(19) United States
(12) Patent Application Publication
(10) Pub. No.: US 2003/0057671 A1
(43) Pub. Date: Mar. 27, 2003

(54) Four wheel steering system

(76) Inventor: Axel Schaedler, Medina, OH (US)

Correspondence Address: EMERSON & SKERIOTIS, Fourteenth Floor, One Cascade Plaza, Akron, OH, 44308-1147, US

(21) Appl. No.: 10/121,486

(22) Filed: Apr. 12, 2002

Related U.S. Application Data
(60) Provisional application No. 60/283,480, filed on Apr. 12, 2001.

(51) Int. Cl. B62D 61/10

(52) U.S. Cl. 280/99; 180/22

(57) ABSTRACT

A six wheeled off-road utility vehicle includes a frame upon which is mounted an engine for use in providing locomotive power to drive the vehicle. A steering wheel is also connected to a steering system for use in providing steering for the ground engaging wheels. Turning the steering wheel rotates a steering column rod about a longitudinal axis and rotates a pinion gear. The first and second front ground engaging wheels are connected to a first axle and first and second rear ground engaging wheels are connected to the second axle. A mechanical linkage is operatively connected between the first and second front ground engaging wheels and the first and second rear ground engaging wheels. The mechanical linkage is engaged in a first linkage direction, the first and second front ground engaging wheels pivot in a first steering direction, and the first and second rear ground engaging wheels pivot in a second steering direction. A steering angle A1 of the first and second front ground engaging wheels forms a steering ratio with the steering angle A2 of the first and second rear ground engaging wheels in the range substantially between 1 and 4.

### 1. BACKGROUND OF THE INVENTION

A. Field of Invention

The present invention relates to the art of steering multiple sets of wheels while other wheels remain unsteerable, and especially to such steering of wheels used on relatively small offroad utility vehicles.

B. Description of the Related Art

It is known in the art to provide small off road utility vehicles having multiple drive wheels and front steerable wheels. Such vehicles typically have a cargo hold for holding cargo of many types. On problem with such vehicles is that they are relatively difficult to steer when they are loaded. Another problem with such vehicles is that they tend to cause damage to the turf when they are loaded and steered simultaneously.

It is known to provide large vehicles that turn (or steer) multiple axles or multiple sets of steering wheels. However, such known vehicles require complex and expensive hydraulic systems to synchronize the steering of all steerable wheels.

What is need is a small utility vehicle that overcomes the steering related difficulties in known vehicles while overcoming the complex system requirements of large vehicles. The present invention overcomes such difficulties inherit in the art in a way that is simple and efficient, while providing better and more advantageous results.

### II. SUMMARY OF THE INVENTION

It is an object of the present invention to provide a small utility vehicle including multiple axles of steering wheels along with unsteerable wheels.

It is another object of the present invention to provide a utility vehicle that utilizes only mechanical linkages to accomplish the steering of the multiple axles of the vehicles.

It is yet another object of the present to steer the frontward wheels at a different angle than the rearward wheels.

Other objects and advantages of the invention will appear from the following detailed description of the preferred embodiment of the invention with reference being made to the accompanying drawings.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a picture of a model of the present invention.

FIG. 2 is a schematic representation of the steering system of the present vehicle.

FIG. 3 is a partial cutaway view of the steering system of the present invention.

FIG. 4 is a partial cutaway view of the steering system of the present invention.

FIGS. 5 through 13 are pictures of a model of the present invention.

### IV. DESCRIPTION OF THE PREFERRED EMBODIMENT

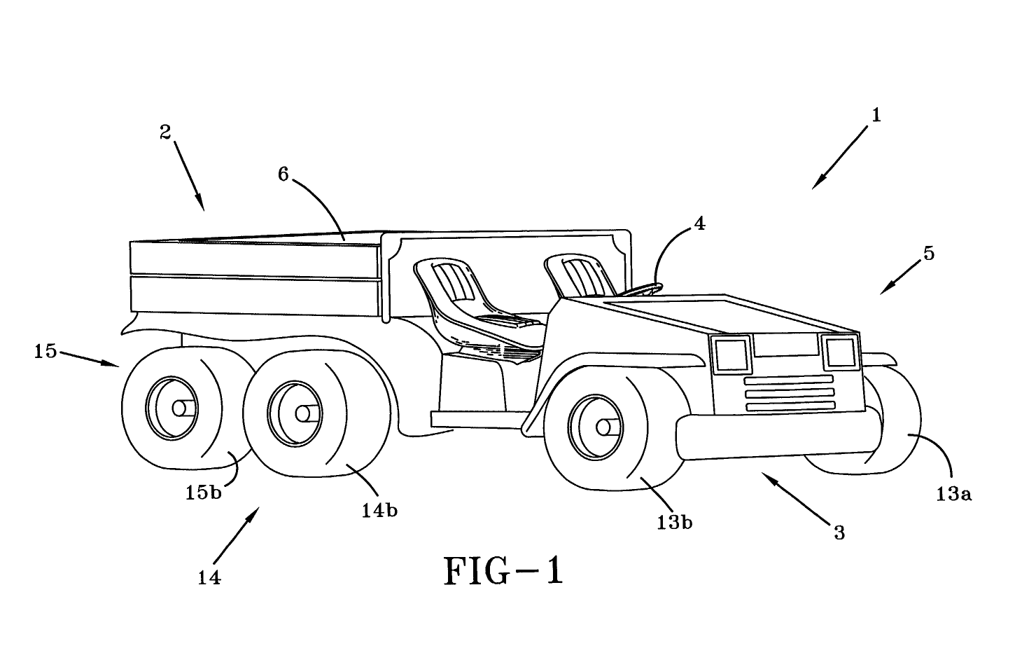

Referring now to the drawings wherein the showings are for purposes of illustrating a preferred embodiment of the invention only and not for purposes of limiting the same, FIG. 1 shows a six (6) wheeled off-road utility vehicle depicted generally at 1. The vehicle 1 includes a frame 3 upon which is mounted an engine 5 for use in providing locomotive power to drive the vehicle 1. The engine 5 may be an internal combustion engine. However, any type of engine may be used that is chosen with sound engineering judgment as is appropriate for providing locomotive power to drive an off road utility vehicle. A transmission, not shown, may be included that is operatively disposed between the engine 5 and the drive axles of the vehicle in a manner well known in the art. However, any means of transmitting locomotive power from the engine 5 to the drive axles may be chosen with sound engineering judgment. In this manner, locomotive power is operatively communicated from the engine 5 to the drive axles and subsequently to the drive wheels for use in providing locomotive power to drive the vehicle 1. In the preferred embodiment, the vehicle 1 may include six (6) ground engaging wheels 13a, 13b, 14a, 14b, 15a, 15b that are rotatably attached to distal ends of axles 13, 14 and 15 respectively. A steering wheel 4 may be also connected to a steering system for use in providing steering for the ground engaging wheels 13a, 13b, 15a and 15b, as will be discussed in detail in a subsequent paragraph. It is noted that the off-road vehicle 1 is designed to carry a payload. The designed payload of the vehicle shown is approximately 1000 pounds but it should be noted that the particular load can vary with this invention. The vehicle 1 may therefore incorporate a cargo hold 6 configured to contain and transport any type of payload chosen with sound operating judgment. Any manner of cargo hold, and configuration thereof, may be chosen with sound engineering judgment as is appropriate for use on a six-wheeled (6) off-road utility vehicle 1. It is noted the cargo hold 6 is disposed toward the rearward end 2 of the vehicle 1, which positions the cargo hold 6 and payload contained therein over two (2) axles 14 and 15. For this reason it is necessary to incorporate three (3) axles having six (6) ground engaging wheels to provide support for the payload capacity as noted above.

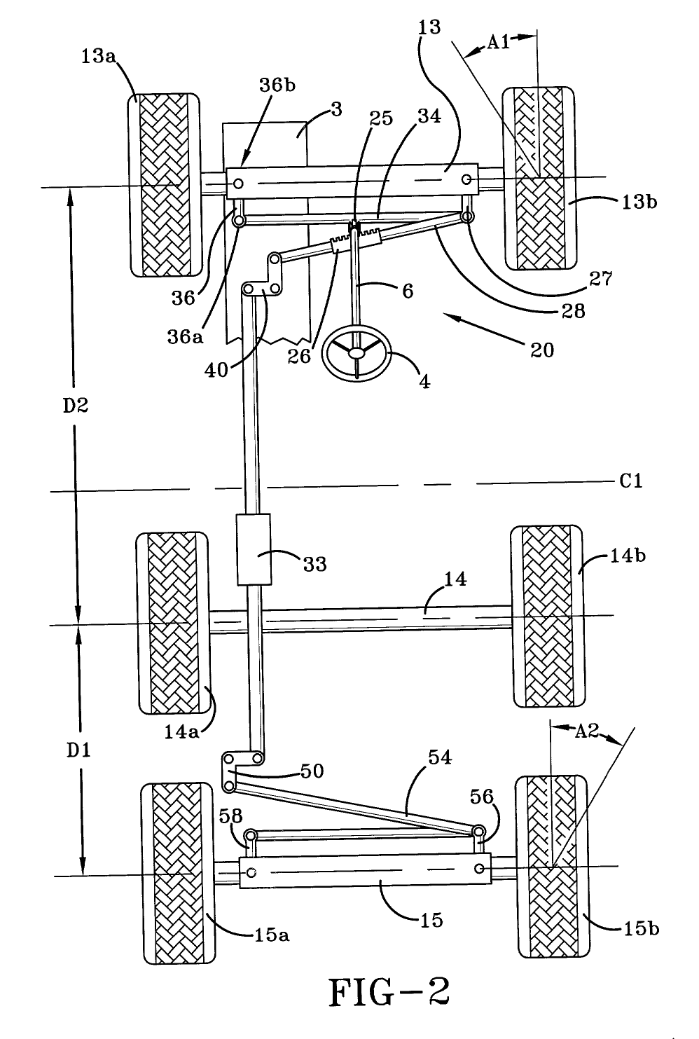

With reference now to FIG. 2, a schematic representation of the chassis of the vehicle 1 is shown, along with the steering system, shown generally at 20. In the preferred embodiment, the steering wheel 4 may be a automobile-like steering wheel. It is noted however, that any means of steering handle or implement may be chosen with sound engineering judgment. The steering wheel 4 is attached to a steering column rod 6 that extends below the vehicle carriage, shown in FIG. 1. A pinion gear 25 may be attached to the opposite end of the steering column. In this manner, a steering column rod 6 has a steering wheel 4 attached at one end and a pinion gear 25 attached at the other end. The pinion gear 25 meshingly engages a rack 26 that may be integrally connected with a first steering rod member 28, shown clearly in FIG. 2. In this manner, turning the steering wheel 4 rotates the steering column rod 6, about a longitudinal axis, and rotates the pinion gear 25. In that the pinion gear 25 meshingly engages the rack 26, torque from the steering wheel is translated into linear motion to the rack 26 and consequently to the first steering rod member 28. In this manner, rotating the steering wheel 4 in a first turning direction A, linearly moves the first steering rod member 28 in a first rod direction B. It is noted at this point, that any means of providing linear actuation of the first steering rod member 28 from the steering wheel 4 may be chosen with sound engineering judgment, which may include hydraulic actuators, vacuum actuators and the like.

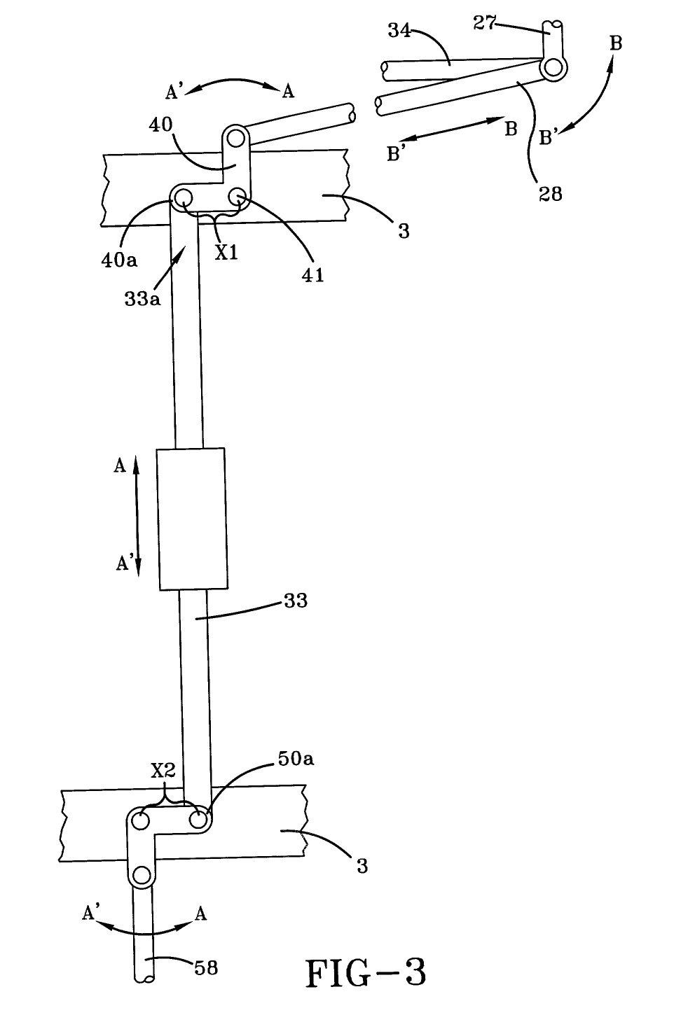

With reference now to FIGS. 2 and 3, the first steering rod member 28 is shown pivotally connected at distal ends between a first extension rod member 27 and a first “L” member 40. It is noted that turning the steering wheel 4 linearly moves the first steering rod member 28 in the direction as indicated by the arrows B & B′ and pivots both the first extension rod member 27 and a first “L” member 40 in the A direction. It is noted that the first “L” member 40 is pivotally attached to the frame at the pivot point 41 in a manner well known in the art and rotates about that point when actuated. A connecting rod member 33 may rigidly connect the first “L” member 40 to a second “L” member 50 as shown in the FIG. 3. Consequently, when the rack 26 is actuated and the first “L” member 40 is pivoted, the connecting rod member 33 causes the second “L” member 50 to pivot in an opposite direction, as will be discussed in the following paragraphs.

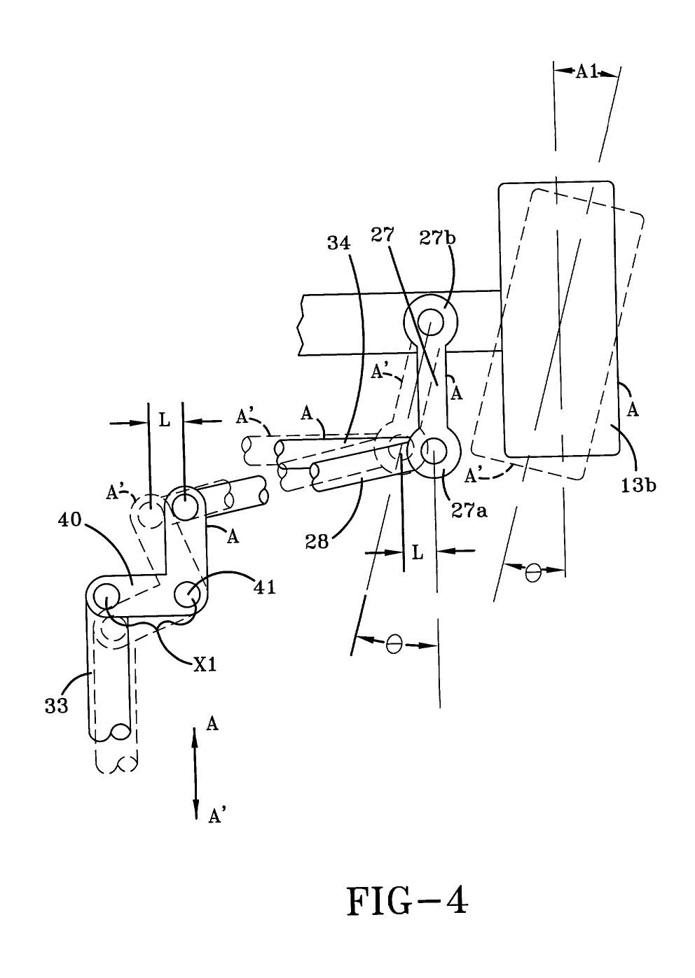

With continued reference to FIGS. 2 and 3, and now to FIG. 4, first extension rod member 27 is shown pivotally connected at one end 27a to the first steering rod member 28 and connected at a second end 27b to the axle 13 and right front ground engaging wheel 13b. The second end 27b of the first extension rod member 27 is pivotally connected with respect to the axle 13 and fixedly connected with respect to the ground engaging wheel 13b. Inasmuch as the pivotal and fixed connection of the various members is known in the art no further explanation will be provided at this time. In fact, any manner of connecting the members as described above may be chosen with sound engineering judgment. In this manner, linearly actuating the first steering rod member 28, as previously discussed, forcefully pivots the first extension member 27 about pivot point 27b and in that the ground engaging wheel 13b is fixedly attached with respect thereto, wheel 13b also pivots in the same direction. It is to be understood and appreciated that a similar operative connection of extension member to ground engaging wheel is provided on the laterally opposing side of the vehicle 1. In other words, second extension member 36 is pivotally connected with respect to the axle 13, at a distal end from the first extension member 27, and fixedly connected to ground engaging wheel 13a for use in pivoting wheel 13a in a similar manner. A tie rod member 34, shown clearly in FIG. 2, rigidly connects the respective ends 27a, 36a of the extension members 27, 36. In this manner, the tie rod member 34 causes the extension members 27, 36 to move substantially in unison. It is noted that any manner of fixing the substantially synchronized movement of the extension member 27, 36 may be chosen with sound engineering judgment. Therefore, it is noted that turning the steering wheel 4 in a first steering direction, linearly actuates the first steering rod member 28, which in turn causes the pivoting of the extension members 27, 36 with respect to the axle 13. The tie rod member 34 links movement of the first extension member 27 to the second extension member 36. In that the ground engaging wheels 13a, 13b move with the extension members 27, 36, wheels 13a, 13b pivot accordingly.

With continued reference to FIGS. 2 and 3, the connecting rod member 33 may provide a rigid connection from the first “L” member 40 to the second “L” member 50 as previously mention. The second “L” member 50, as the first “L” member, is pivotally connected with respect to the frame 3 of the vehicle 1. The connecting rod member 33 is pivotally attached at a first end 33a to the portion 49a of the first “L” member. Likewise, second end 33b of the connecting rod member 33 is attached to portion 50a of the second “L” member. As the rack 26 is actuated in a first linear direction, via steering wheel 4, first “L” member 40 pivots accordingly, wherein portion of the 40a, being an integral part thereof, pivots causing the connecting rod member 33 to move in direction A, as shown in clearly FIG. 3. This in turn transmits force, via portion 50a, to pivot second “L” member 50. It is noted that the “L” members 40, 50 are connected via connecting rod member 33 such that a clockwise movement of the first “L” member 40 causes a counter-clockwise movement of the second “L” member 50 and vice verse. This allows the steered rear ground engaging wheels 15a, 15b to steer opposite the front ground engaging wheels 13a, 13b as will be discussed presently.

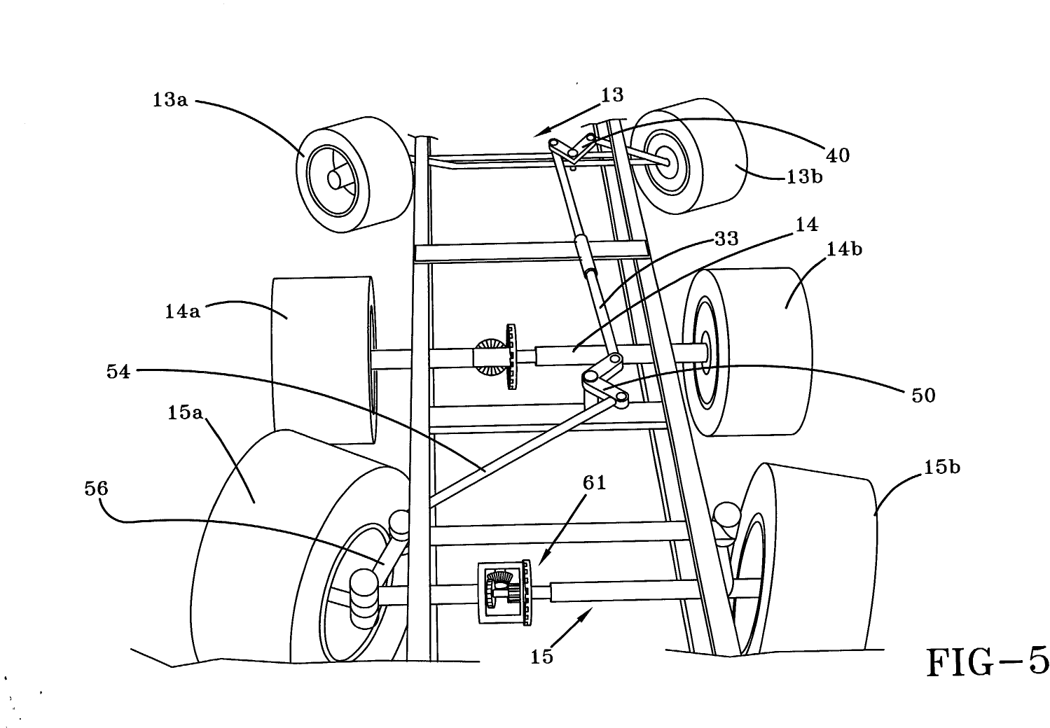

With continued reference to FIG. 2 and now to FIG. 5, a second steering rod member 54 is shown connected at one end to second “L” member 50 and at the distal end to a first rearward extension member 56. The rearward extension member 56 is pivotally connected to the distal end of the second steering rod member 54. Similar to that of the front extension member 27, first rearward extension member 56 is fixedly connected with respect to ground engaging wheel 15b and pivotally connected with respect to the frame 3 in the rearward portion 2 of the vehicle 1. Likewise, a second rearward extension member 58 is connected to the first rearward extension member 56 by way of a second tie rod member 59. The interconnection of the tie rod members to the extension members is the same for the first tie rod member 34 as it is to the second tie rod member 59. In that the interconnection of the second tie rod member 59 is similar to the interconnection of the first tie rod connection 34, no further explanation will be offered at the this point. In this way, turning of the steering wheel 4 in a first direction, simultaneously causes the front ground engaging wheels 13a, 13b to pivot or steer in the first steering direction and causes the rear ground engaging wheels 15a, 15b to pivot or steer in the opposite or second steering direction. This allows the vehicle 1 to make extremely tight turns, as is necessary for use in traversing off road terrain with a substantial payload held in the cargo hold.

With continued reference to FIG. 2 and now to FIG. 5, all six (6) of the ground engaging wheels 13a, 13b, 14a, 14b, 15a and 15b may be drive wheels. However, in the preferred embodiment, the rearward four wheels 14a, 14b, 15a and 15b are driven by the prime mower 5, such as an internal combustion engine 5. As the two front wheels 13a, 13b are rotatably and pivotally, or steerably, attached to distal ends of a front axle 13, the middle two wheels 14a, 14b are rotatably attached at opposite ends to the middle axle 14. However, the wheels 14a, 14b are only rotatably attached to the axle 14 and not pivotally attached thereto. It is noted that the middle, or center, axle 14 may be disposed toward the rear 2 of the vehicle 1 offset from a centerline C1 of the vehicle 1, shown in FIG. 2. The offset relationship of the middle axle 14 is needed to support the payload capacity of the cargo hold 6. In other words, the cargo hold 6 is disposed over the middle axle 14 and the rear axle 15 for use in supporting any cargo being transported by the vehicle 1.

The distance between middle axle 14, the axle supporting the middle set of wheels 14a, 14b, and the rear axle 15 is labeled D1 and the distance from the middle axle 14 to the front axle 13 is labeled D2. In the configuration where D1 is equal to D2, the degree of turning between the frontward and rearward steering wheels would be equal. However in one embodiment, the distance D2, from the middle axle to the front axle, is double D1, the distance from the center axle to rear axle. In this configuration, it is desired that the rear wheels only turn one-half the amount of the front wheels.

With continued reference to FIG. 5, the rear ground engaging wheel 15a, 15b pivot or steer to a lesser degree than do the front steering wheels 13a, 13b. However, it is noted that the front and rear steering wheels still turn simultaneously in response to the adjustment of a single steering wheel 4. The magnitude of steering difference in the degree of turning between the two sets of wheels may depend on the distance of each of the front 13 and rear 15 axles in relation to the middle axle 14. In other words, if the distance D2, which is the distance from the longitudinal axis of the axle 13 to the longitudinal axis of the middle axle 14 as shown clearly in FIG. 2, is four times the distance of D1, which is the distance from the longitudinal axis of the axle 15 to the longitudinal axis of the middle axle 14, then the ratio of steering of the front ground engaging wheels 13a, 13b to the wheels 15a, 15b is respectively four. In this manner, a ratio is defined as the steering angle A1 of the front ground engaging wheels 13a, 13b to the steering angle A2 of the rear ground engaging wheels 15a, 15b. This ratio may reside from 1 to 8. However, in the preferred embodiment, the ratio is 2. Additionally, the ratio A1/A2 may depend on the ratio D2/D1 as previously mentioned.

With continued reference to FIG. 5, locomotive power may be transmitted to the middle 14 and rear 15 axles as previously mentioned. A differential 61 may be operatively disposed in line with the rear axle 15 for use in allowing the rear ground engaging wheels 15a, 15b to turn at different rates of speed to prevent skidding or dragging of the one of the wheels. In the preferred embodiment, power may be directly transmitted to the middle axle 14 by any means chosen with sound engineering judgment.

With references again to FIGS. 2 and 3, and particular reference to FIG. 4, the steering angles of the steering wheels will now be discussed. A ratio exists between the amount of linearly displacement L of the front steering rod member 28 and the angle whereby the respective extension members 27, 36 are rotated, labeled Θ (Theta). The angle of rotation may be determined by the length R of the extension members 27, 36, via the geometric equation: Tangent Θ equals L divided by R (Tan Θ=L/R). This relation is shown clearly in FIG. 4 by the right triangle. In other words, the greater the length of the extension members 27, 36, the greater the degree that the extension members 27, 36 rotate through the angle Θ. Should the front 27, 36 and rear 56, 58 extension members have different lengths, with respect to the front and rear axles, the respective extension members, and consequently the wheels attached thereto, will rotate through different angles. In this manner, the front and rear steering wheels may be steered at different angles of rotation by varying the length of the front extension members with respect to the rear extension members. In an alternate embodiment, the same affect can be accomplished by varying the length of the first 40 and second 50 “L” members. That is to say, that if the portion 40a, the length X1 (shown in FIG. 3) from the point of connection of the connecting rod member 33 to the pivot point 41 is shorter than the portion 50a, the length X2 (shown in FIG. 3), the from the point of connection of the distal end of the connecting rod member 33 to the pivot point 50a, then the front steering wheels 13a, 13b will steer through a greater angle with respect to the rear steering wheels 15a, 15b proportionately.

It is also contemplated, that steering the vehicle may include a power-assisted mechanism to aid the operator in steering the vehicle. This may include a vacuum actuator as powered by the vacuum produced the engine of the vehicle or by a separate vacuum source such as a vacuum pump. The vacuum device may be operatively connected to the second connecting rod. However, any means of assisted power steering may be chosen with sound engineering judgment.

While specific embodiments of the invention have been described and illustrated, it is to be understood that these embodiments are provided by way of example only and that the invention is not to be construed as being limited thereto but only by proper scope of the following claims.

Having thus described the invention, it is now claimed:

I/We claim:

1. An off-road vehicle having a frame, the frame having front and rear portions, a first axle operatively connected the front portion of the frame, a second axle operatively connected to the rear portion of the frame, an engine operatively connected to the frame for use in providing locomotive power to drive the vehicle, the vehicle comprising:
first and second front ground engaging wheels being rotatably and pivotally connected to the first axle;
first and second rear ground engaging wheels being rotatably and pivotally connected to the second axle, wherein locomotive power from the engine is operatively communicated to drive the first and second rear ground engaging wheels;
a mechanical linkage operatively connected between the first and second front ground engaging wheels and the first and second rear ground engaging wheels, the mechanical linkage operatively adapted to the steerably engage the first and second front ground engaging wheels and the first and second rear ground engaging wheels, wherein when the mechanical linkage is engaged in a first linkage direction the first and second front ground engaging wheels pivot in a first steering direction and the first and second rear ground engaging wheels pivot in a second steering direction;
a mechanical steering mechanism operatively communicated to the mechanical linkage, the mechanical steering mechanism being selectively steerable in the first and second steering directions; and,
wherein the steering angle A1 of the first and second front ground engaging wheels forms a steering ratio with the steering angle A2 of the first and second rear ground engaging wheels in the range substantially between 1 and 4.

2. The vehicle of claim 1, further comprising:
a third axle operatively connected to the frame at a longitudinal position between the first and second axles;
first and second middle ground engaging wheels rotatably connected to the third axle, wherein locomotive power from the engine is operatively communicated to the first and second middle ground engaging wheels;

3. The vehicle of claim 1, wherein the mechanical linkage further comprises: a rack having gear teeth; and,
wherein the mechanical steering mechanism further comprises:
a pinion gear meshingly communicated with the rack for use in engaging the mechanical linkage in first and second linkage directions; and,
a steering wheel operatively connected to the pinion gear.

4. The vehicle of claim 3, further comprising:
at least a first front tie rod operatively connected at a respective first front tie rod end to the mechanical linkage, the at least a first front tie rod operatively connected at a respective second front tie rod end to the first ground engaging wheel;
at least a first rear tie rod operatively connected at a respective first rear tie rod end to the mechanical linkage, the at least a first rear tie rod operatively connected at a respective second rear tie rod end to the first ground engaging wheel;
wherein the length L1 of the at least a first front tie rod forms a ratio with the length L2 of the at least a first rear tie rod in the range between 1 and 4.

5. An off-road vehicle, comprising:
a frame;
an engine operatively connected to the frame;
first and second front ground engaging wheels operatively connected to pivot in a first direction;
first and second rear ground engaging wheels operatively connected to pivot in a second direction, wherein the first direction is opposite the second direction, wherein locomotive power from the engine is operatively communicated to drive the rear ground engaging wheels;
steering linkage operatively communicated between the first and second front ground engaging wheels and the first and second rear ground engaging wheels, the steering linkage being operatively adapted to steer each of the front and rear ground engaging wheels;
a steering wheel operatively connected to the steering linkage for use in steering all of the front and rear ground engaging wheels; and
a middle axle member having first and second middle ground engaging wheels disposed at distal ends of the middle axle member.

6. The off-road vehicle of claim 5, wherein the middle axle member is longitudinally disposed rearward of a centerline of the off-road vehicle.

7. The off-road vehicle of claim 6, wherein locomotive is operatively communicated to drive the first and second middle ground engaging wheels.
